(19) United States
(12) Patent Application Publication
(10) Pub. No.: US 2004/0120653 A1
(43) Pub. Date: Jun. 24, 2004

(54) Optical fiber joint

(76) Inventors: Zen-Chyuan Chen, Junghe City (TW); Kuo-Chiang Wu, Junghe City (TW)

Correspondence Address: RABIN & BERDO, P.C., Suite 500, 1101 14 Street, N.W., Washington, DC, 20005, US

(21) Appl. No.: 10/322,742

(22) Filed: Dec. 19, 2002

(51) Int. Cl. G02B 6/36

(52) U.S. Cl. 385/78

(57) ABSTRACT

An optical fiber joint for inserting into an optical fiber connecting seat includes an optical fiber conduction wire, an octagonal plug and an optical fiber holding body; the octagonal plug has an insertion portion with wall planes in the shapes of octagonal rectangles; an optical fiber receiving body with a hollowed center is disposed at a distal end of the insertion portion; the optical fiber holding body is located at the central hollow area of the optical fiber receiving body; the optical fiber conduction wire penetrates the circular hole of the optical fiber holding body so as to form an optical fiber joint not limited in the upper and lower directions.

### BACKGROUND OF THE INVENTION

1) Field of the Invention

The present invention relates to an optical fiber joint, more particularly to an octagonal joint to be used for the optical fiber and connected with an optical fiber connecting seat so as to not be limited in the upper and lower directions thereof.

2) Description of the Prior Art

Accordingly, along with the advance of technology, the advantages of having high speed, wideband, precise transmission signal and steadiness make the optical fiber system the main focus of research and development of all the telecommunication manufacturers. The usage of the optical fiber has been elevated by the request of fiber to the home (FTTH) and fiber to the desk (FTTD). Local network is also gradually fiberized. Therefore the need of using an optical fiber connector in the telecommunication industry has been fast augmented. As indicated in FIG. 1, a connector used in a conventional optical fiber system has an optical fiber joint (2) fixedly connected at one end of an optical fiber conduction wire (1) for movably inserting the optical fiber joint (2) into an optical fiber connecting seat (3).

Since the optical fiber conduction wire uses the light as the media for transmitting the signal, the structure of the optical fiber connector has to be very precise for correctively transmitting the optical signal inside the optical fiber. Therefore, the optical fiber joint must be tightly connected into the optical fiber connecting seat. However, different from the electric signal, the optical signal has neither positive or negative properties nor directionality. The traditional optical fiber joint only inserts correctively through aiming from one direction into the optical fiber connecting seat thereby having limited application.

In view of the inconvenience and shortcomings of the currently available optical fiber connector, the inventor researched and developed an improved structure of an optical fiber joint with altered shapes of an insertion portion to achieve the efficiency of not being limited in the upper and lower directions so as to conveniently insert into the optical fiber connecting seat; the design of the present invention is rational and capable of effectively improving the abovementioned shortcomings.

### SUMMARY OF THE INVENTION

The primary feature of the present invention that an optical fiber joint for inserting into an optical fiber connecting seat includes an optical fiber conduction wire, an octagonal plug and an optical fiber holding body; the octagonal plug has an insertion portion with wall planes in the shapes of octagonal rectangles; an optical fiber receiving body with a hollowed center is disposed at a distal end of the insertion portion; the center inside the insertion portion extends outwardly to form a hollowed circular cylinder; the optical fiber holding body is located at the central hollow area of the optical fiber receiving body; one end thereof forms two parallel clip tabs with a through circular hole disposed at the center; the optical fiber conduction wire penetrates the circular hole of the optical fiber holding body and extends to the front end of the hollowed circular cylinder; the two parallel clip tabs fixedly clamp the optical fiber conduction wire so as to form an optical fiber joint not limited in the upper and lower directions.

The secondary feature of the present invention is that the hollow portion inside the optical fiber receiving body is in a flare shape with a small interior portion and a large external portion capable of squeezing the two parallel clip tabs of the optical fiber holding body for clamping the optical fiber conduction wire.

Another feature of the present invention is that at least one recess is disposed inside the optical fiber receiving body; at least one flange is disposed on the two parallel clip tabs of the optical fiber holding body opposite the recess area for inserting and connecting the optical fiber holding body into the optical fiber receiving body.

Yet another feature of the present invention is that at least one shallow concave plane is disposed on the wall plane in the shape of an octagonal rectangle of the insertion portion; a flange disposed on the shallow concave plane is vertical to the optical fiber conduction wire for inserting the octagonal plug into the optical fiber connecting seat.

To enable a further understanding of achieving the abovementioned objectives, the technical contents and the effectiveness of the present invention, the brief description of the drawings is followed by the detailed description of a preferred embodiment. However, the attached figures are provided for references and illustration only, but not for limiting the application scope of the present invention.

### BRIEF DESCRIPTION OF THE DRAWINGS

FIG. 1 is a drawing of a connector used in a conventional optical fiber system.

FIG. 2 is a pictorial and schematic drawing of an optical fiber joint of the present invention.

FIG. 3 is a pictorial and exploded drawing of FIG. 2.

FIG. 4 is a cross-sectional and schematic drawing of A-A in FIG. 2.

### DETAILED DESCRIPTION OF THE PREFERRED EMBODIMENTS

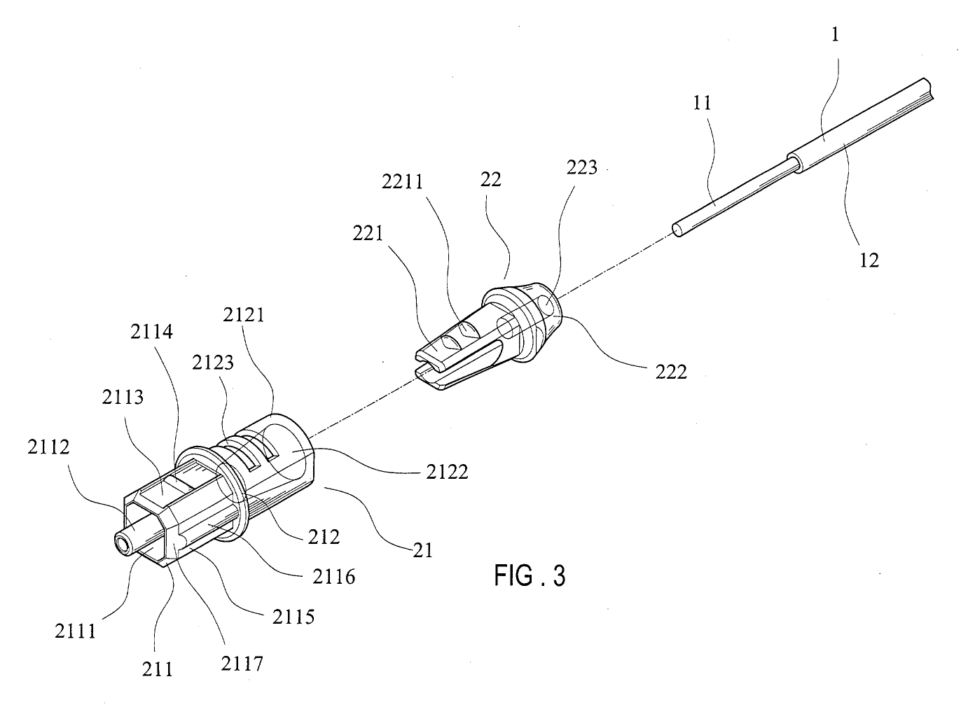

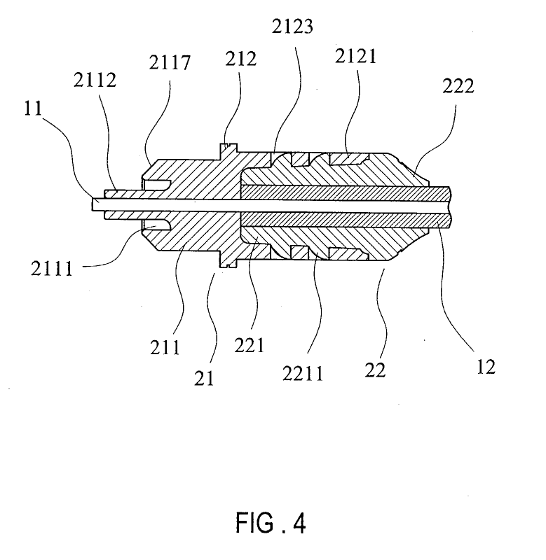

FIG. 2 shows the pictorial and schematic drawing of an optical fiber joint of the present invention; FIG. 3 shows the pictorial and exploded drawing of FIG. 2; FIG. 4 shows the cross-sectional and schematic drawing of A-A in FIG. 2. An octagonal optical fiber joint (20) of the present invention inserts into a traditional optical fiber connecting seat (3) and mainly comprises an optical fiber conduction wire (1), an octagonal plug (21) and an optical fiber holding body (22); wherein the optical fiber conduction wire (1) is a traditional optical fiber body with a single core and shielded by a layer of external cover (12) made of soft plastic or rubber. However, the present invention can be used for an optical fiber conduction wire (1) with multiple cores in the same structure. Therefore, only the embodiment of the optical fiber conduction wire (1) with a single core is used for describing the present invention but not for limiting the application scope of the present invention.

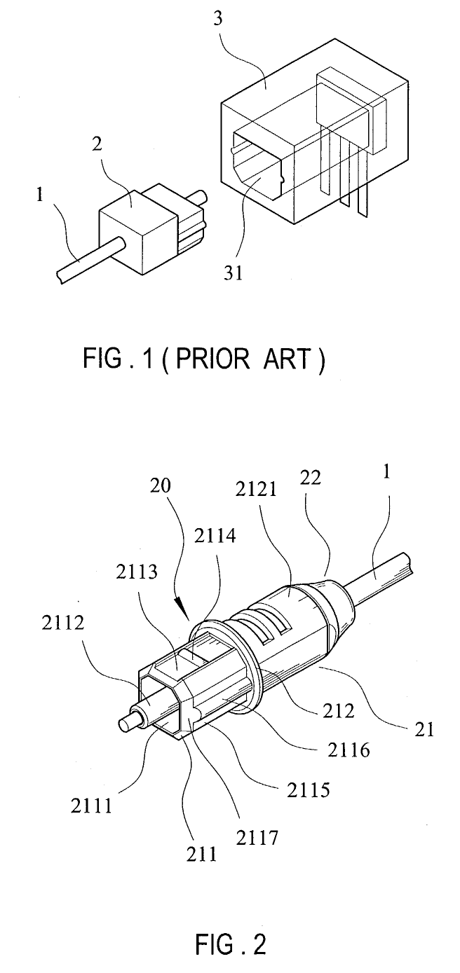

As indicated in FIG. 1, an insertion hole (31) of the optical fiber connecting seat (3) is of a hexagonal shape. Therefore, the conventional optical fiber plug (2) must align with the shape of the insertion hole (31) for inserting into the optical fiber connecting seat (3). The present invention specifically designed an octagonal plug (21) to have one end thereof formed as an insertion portion (211) with wall planes in the shapes of octagonal rectangles; the upper and lower directions thereof are not limited for inserting into the optical fiber connecting seat (3). A distal end of the insertion portion (211) is disposed with a stop flange (212) for stopping the insertion of the octagonal plug (21).

A receiving space (2111) is formed inside the insertion portion (211); wherein the central area thereof extends to form a hollowed circular cylinder (2112); a shallow concave plane (2113) is respectively disposed on two upper and lower horizontal wall planes of the wall planes in the shapes of octagonal rectangles. A rectangular convex block (2114) disposed on the shallow concave plane (2113) is vertical to the optical fiber conduction wire (1) for inserting the octagonal plug (21) into the optical fiber connecting seat (3).

Furthermore, a flange (2116) in the shape of a long strip disposed on two left and right vertical wall planes (2115) of the wall planes in the shapes of octagonal rectangles of the insertion portion (211) is parallel to the optical fiber conduction wire (1); the front end (2117) of the wall planes in the shapes of octagonal rectangles of the insertion portion (211) is of a conic shape with slanted sides; both of them are for guiding the insertion portion (211) of the octagonal plug (21) to easily insert into the optical fiber connecting seat (3).

In addition, an optical fiber receiving body (2121) with a hollowed center is disposed at the rear end of the stop flange (212) for receiving the insertion of the optical fiber holding body (22); the hollow interior of the optical fiber receiving body (2121) is a circular hole (2122) in a flare shape with a small interior portion and a large external portion. One end of the optical fiber holding body (22) forms two parallel clip tabs (221) similar to the shape of a duck beak. The other end forms a buffer convex portion (222); the center of the optical fiber holding body (22) is disposed with a through circular hole (223) for receiving the optical fiber body (11). The optical fiber body (11) penetrates and extends from the optical fiber holding body (22) which further inserts into the optical fiber receiving body (2121); the flare-shaped circular hole (2122) of the optical fiber receiving body (2121) squeezes the two parallel clip tabs (221) of the optical fiber holding body (22) for holding and fixing the optical fiber conduction wire (1). The optical fiber conduction wire (1) inserts into the optical fiber receiving body (2121) via the optical fiber holding body (22) to extend forwardly to the front end of the hollowed circular cylinder (2112) or even extends outside.

The upper and lower rims inside the optical fiber receiving body (2121) are respectively disposed with two concave slots (2123) which can be rectangular holes penetrating the wall planes of the optical fiber receiving body (2121); on the externally lateral sides of the two parallel clip tabs (221) of the optical fiber holding body (22), opposite the positions of the concave slots (2123), two convex blocks (2211) are respectively disposed to fitly insert into the concave slots (2123) for connecting the optical fiber holding body (22) into the optical fiber receiving body (2121).

Therefore, through the above disclosed technical contents, the optical fiber joint of the present invention is capable of specifically providing a structural design completely different from the conventional structure for enhancing the application value of the entire unit.

It is of course to be understood that the embodiment described herein is merely illustrative of the principles of the invention and that a wide variety of modifications thereto may be effected by persons skilled in the art without departing from the spirit and scope of the invention as set forth in the following claims.

1. An optical fiber joint inserted into an optical fiber connecting seat comprising:
an optical fiber conduction wire disposed with an optical fiber body and shielded by an external cover;
an octagonal plug with one end thereof formed as an insertion portion with wall planes in the shapes of octagonal rectangles; the distal end of the insertion portion is disposed with a stop flange; the rear end of the stop flange is disposed with an optical fiber receiving body with a hollowed center; the interior portion of the insertion portion forms a receiving space and the center thereof extends to form a hollowed circular cylinder;
an optical fiber holding body received in the hollowed central area of the optical fiber receiving body; one end thereof forms two parallel clip tabs; the other end thereof forms a buffer convex portion; the center thereof is disposed with a circular hole penetrating the optical fiber holding body;
wherein, the optical fiber body penetrates the circular hole of the optical fiber holding body and extends to the front end of the hollowed circular cylinder; the two parallel clip tabs hold and fix the optical fiber conduction wire.

2. The optical fiber joint according to claim 1, wherein at least one shallow concave plane is disposed on the wall planes in the shapes of octagonal rectangles of the insertion portion; a convex block disposed on the shallow concave plane is vertical to the optical fiber conduction wire for inserting the octagonal plug into the optical fiber connecting seat.

3. The optical fiber joint according to claim 1, wherein at least one flange horizontal to the optical fiber conduction wire is disposed on the wall planes in the shapes of octagonal rectangles of the insertion portion for guiding the octagonal plug into the optical fiber connecting seat.

4. The optical fiber joint according to claim 1, wherein the front end of the wall planes in the shapes of octagonal rectangles of the insertion portion is of a conic shape with slanted sides for guiding the insertion portion to insert into the optical fiber connecting seat.

5. The optical fiber joint according to claim 1, wherein the interior hollow portion of the optical fiber receiving body of the octagonal rectangles is of a flare-shaped circular hole with a small interior portion and a large external portion for squeezing the two parallel clip tabs of the optical fiber holding body to hold the optical fiber conduction wire.

6. The optical fiber joint according to claim 5, wherein at least one concave slot is disposed inside the optical fiber receiving body; on the two parallel tabs of the optical fiber holding body, opposite the position of the concave slot, at least one convex block is disposed to insert the optical fiber holding body into the optical fiber receiving body.

7. The optical fiber joint according to claim 6, wherein the concave slot is a rectangular hole penetrating the wall plane of the optical fiber receiving body.
